(19) United States
(12) Patent Application Publication
(10) Pub. No.: US 2023/0321759 A1
(43) Pub. Date: Oct. 12, 2023

(54) LASER PLOTTER

(71) Applicant: Trotec Laser GmbH, Marchtrenk (AT)

(72) Inventor: Ronald Wögerbauer, Thalheim bei Wels (AT)

(21) Appl. No.: 18/003,513

(22) PCT Filed: May 27, 2021
(86) PCT No.: PCT/AT2021/060183

§ 371 Date: Dec. 28, 2022

(30) Foreign Application Priority Data
Jun. 29, 2020 (AT) A50544/2020

(51) Int. Cl. B23K 26/36; B23K 26/12; B23K 26/16; B23K 26/08

(52) U.S. Cl. CPC B23K 26/36; B23K 26/127; B23K 26/16; B23K 26/0876

(57) ABSTRACT

The invention relates to a laser plotter (2) for processing a job for cutting, engraving, marking and/or lettering a preferably flat workpiece (7), which plotter has at least one housing (3) with a preferably closable processing chamber (8) for positioning a workpiece (7) on a processing table (9), at least one irradiation source in the form of a laser (5,6), and a controller (13) for controlling the carriage (14), which is operated by means of preferably a belt drive, with a focusing unit (12) arranged movably thereon, which is designed to deflect a laser beam (10) in the direction of the workpiece (7), wherein an extraction device (1) for extracting the exhaust gases (25) produced during the laser process by generating an air flow (26) is arranged in the processing chamber (8) below the processing table (9), in particular beneath a support surface (27) of the processing table (9). The processing table (9) is designed in such a way that the support surface (27) of the processing table (9) is designed to extend over the entire surface and is in particular airtight, and that, in order to form an air stream (26), an extraction channel (27) is arranged below the support surface (27), preferably parallel to the support surface (27), which extraction channel ends in an exhaust opening (29), wherein the extraction channel (27) is connected via at least one extraction opening (28,29) to the processing chamber (8) for extracting the exhaust gases or vapors, respectively (25), produced during the laser process.

The present invention relates to a laser plotter for processing a job for cutting, engraving, marking and/or lettering a preferably flat workpiece, which plotter has at least one housing with a preferably closable processing chamber for positioning a workpiece on a processing table, at least one irradiation source in the form of a laser, and a control unit for controlling the carriage, which is operated by means of preferably a belt drive, with a focusing unit arranged movably thereon, which is designed to deflect a laser beam in the direction of the workpiece, wherein an extraction device for extracting the exhaust gases produced during the laser process by means of a generated air flow is arranged in the processing chamber below the processing table, in particular a support surface of the processing table, as described in claims 1 and 5.

From the prior art laser plotters in which the exhaust gases from the cutting/engraving process are extracted in a wide variety of ways are known.

On the one hand, laser plotters are known that are equipped with a belt-driven carriage on which a focusing unit can be moved as well. Preferably, here flat workpieces such as paper, sheets, textiles, etc. are processed using a laser, in particular a laser beam. In order to extract the exhaust gases or vapors, respectively, that are generated during the processing, extraction devices are arranged on the carriage. Here, an extraction hose is arranged in the area of the focusing unit.

The disadvantage here is that when an extraction hose is used on the focusing unit, this restricts the mobility, in particular the travel speed of the focusing unit with the extraction hose attached.

On the other hand, such laser plotters are known in which the processing table is formed by a perforated plate or grids or struts, wherein the workpiece is placed on the processing table for cutting or engraving. Below the processing table, there is an extraction pipe connected to an extraction device for extracting the exhaust gases from the workpiece, i.e. the exhaust gases are extracted downwards.

A disadvantage of the methods known from the prior art is that when cutting or engraving, respectively, in particular large flat workpieces, such as an acrylic glass plate, it is not possible to extract the gases produced, as this is possible only via an extraction bar that must be positioned above the workpiece, so that integration of the extraction system into the housing of the laser plotter is not possible.

The objective of the present invention is to create a method and a laser plotter in which the above-mentioned disadvantages are avoided and, on the other hand, the exhaust gas management is substantially improved.

The objective is achieved by the invention.

The objective of the present invention is achieved by a laser plotter in which the processing table is designed so that the support surface of the processing table is designed to extend over the entire surface and is in particular airtight, and that, in order to air stream, an extraction channel is arranged below the support surface, preferably parallel to the support surface, which extraction channel ends in an exhaust opening, wherein the extraction channel is connected via at least one extraction opening to the processing chamber for extracting the exhaust gases or vapors, respectively, produced during the laser process.

The advantage here is that this generates a specific air flow in the processing chamber in the direction of the extraction openings. At the same time, there are thus no bulky additional parts on the carriage or hoses, so that the processing speed does not have to be restricted despite the directed suction air flow, as is often necessary with the prior art.

At the same time, it is made possible that a sufficiently large extraction system can be integrated in the housing of the laser plotter, which can be arranged below the processing chamber, since sufficient room is available below the processing chamber.

Advantageous embodiments are such in which an end plate is arranged parallel to the full-surface support surface, which forms the extraction channel by means of a corresponding design, or an extraction channel is arranged. This ensures that, on the one hand, exhaust gases are prevented from being aspirated downwards, so that they are extracted in parallel to the support surface in the direction of the exhaust opening, and, on the other hand, a cost-effective design is achieved. By a so-called double-bottom design, the extraction channel can be formed by simply placing a separating element.

Advantageous embodiments are such in which the exhaust opening is arranged in the end plate, wherein the extraction channel is preferably formed tapered towards the exhaust opening. This ensures that all exhaust gases drawn into the extraction channel via the extraction openings are directed to the exhaust opening and thus safely removed from the processing chamber.

However, advantageous embodiments are also such in which the end plate is arranged at a defined distance from the support surface. This ensures that an appropriately dimensioned channel is created below the support surface in a simple manner.

In an advantageous embodiment, the processing chamber is bounded by a bounding frame, and the end plate is arranged below the bounding frame and preferably fixed to the bounding space. This ensures that no air can be drawn into the channel below the support surface of the processing table via the border area. This creates an air flow into the channel only through a specially designed channel.

However, advantageous embodiments are also such in which the extraction channel is integrated in the boundary frame and/or between the boundary frame and the end plate. This ensures that the air can be extracted from the processing chamber only via this extraction channel. Preferably, the extraction channel is arranged in the rear border area so that the gas generated during the laser processing is drawn to the rear and the user has a clear view of the inserted workpiece from the front.

Advantageous embodiments are also such in which the extraction channel is connected to an extraction space below the end plate, wherein the extraction space is connected to the extraction device, in particular an extraction fan for discharging the air flow with the exhaust gases from the laser process. This ensures that a simple structure is formed by a so-called double bottom, wherein this is preferably separated in a certain area so that the gases cannot spread over the entire surface between the processing table and the end plate.

However, advantageous embodiments are also such in which the extraction space is limited to a partial area of the processing chamber. This ensures that a higher flow velocity is achieved.

Advantageous embodiments are also such in which the extraction device is positioned in the center underneath the processing table and a part of the processing area is separated by blocking elements. This ensures that sufficient room is available and an appropriately dimensioned extraction device, in particular a pump, can be installed.

However, advantageous embodiments are also such in which the support surface of the processing table is arranged above the bounding frame. This ensures that the entire processing area can be used, since with an appropriately large workpiece the air can flow in laterally between the workpiece and the boundary frame to generate the air flow

Advantageous embodiments are such in which the support surface of the processing table is formed by air ducts, in particular slats oriented from the front to the rear. This ensures that an air flow is formed in each section in the direction of the extraction channel from front to back. Furthermore, it is possible that, with the appropriate design, the individual segments between the air ducts can be closed off, whereby an increase in the flow velocity is achieved. In this case, it is advantageous to use an automatic shut-off system which, depending on the position of the focusing unit, shuts off the more distant segments between the air ducts.

Advantageous embodiments are also such in which the air ducts, in particular the slats, extend over an upper side of the boundary frame, in particular over a height of 5 to 20 mm. This ensures that there is an appropriately large air flow volume between the air ducts, ensuring that the exhaust gases produced are safely removed.

Advantageous embodiments are such in which the slats are evenly distributed over the processing width of the support surface. This ensures that a constant exhaust gas flow is achieved over the entire surface.

Advantageous embodiments are such in which the slats are formed of acrylic glass. This allows easy low-cost manufacturing. At the same time, the weight acting on the processing table is reduced.

Advantageous embodiments are such in which the slats have a thickness between 2-10 mm, preferably 5 mm. This provides a sufficient support surface for workpieces.

Advantageous embodiments are such in which the slats are formed as an assembly that can be inserted into the boundary frame and replaced. This means that the entire slat unit can be replaced in a single operation, enabling optimal adaptation of the exhaust ducts to a wide variety of processes. For example, when processing larger objects, such as an acrylic glass plate, the slat spacing can be selected to be very large, whereas, for example, when engraving a cell phone, a slat unit with a small slat spacing is used to form a good support surface for the cell phone.

Finally, advantageous embodiments are such where the slats extend from the support surface to the end plate. This ensures that the exhaust gases are conveyed along the slats to the extraction channel.

The invention is described hereinafter in the form of an exemplary embodiment, wherein attention is drawn to the fact that the invention is not limited to the exemplary embodiment or solution, respectively, represented and described.

The figures show:

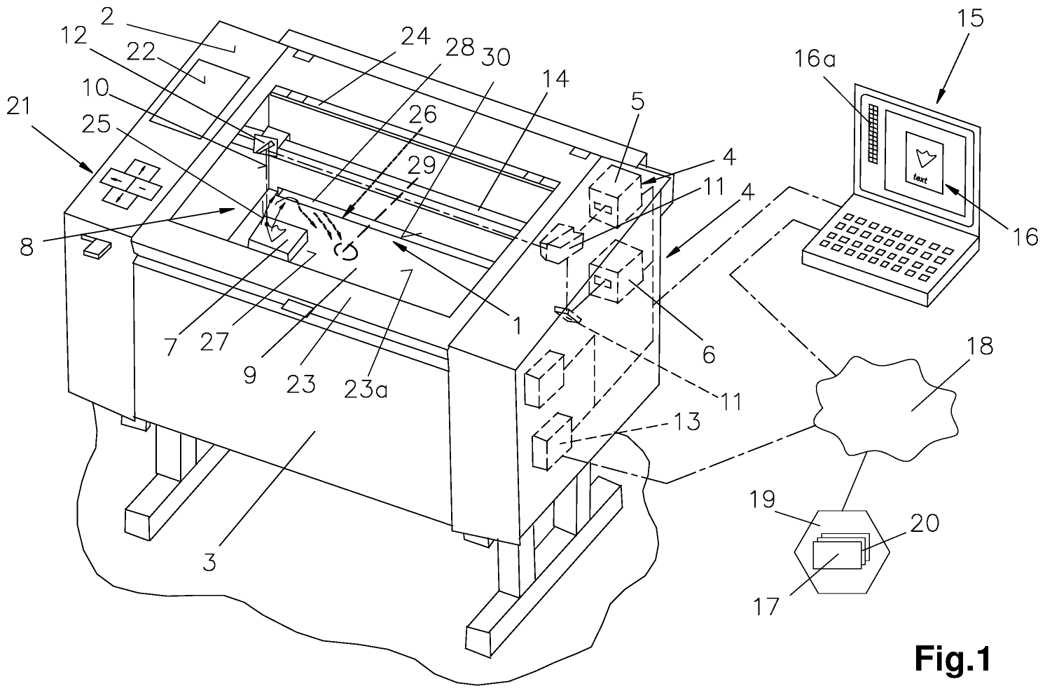

FIG. 1—a schematic illustration of a laser plotter with an exhaust device for extracting the exhaust gases produced during the laser process; simplified, for illustrative purposes only;

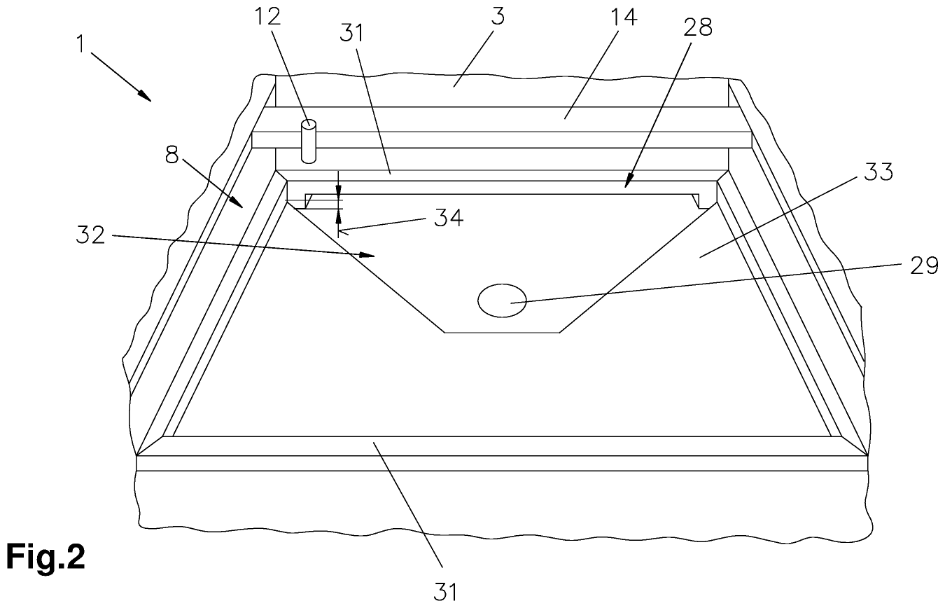

FIG. 2—a simplified schematic illustration of the processing chamber of the laser plotter, with the support surface of the processing table removed; simplified, for illustrative purposes only;

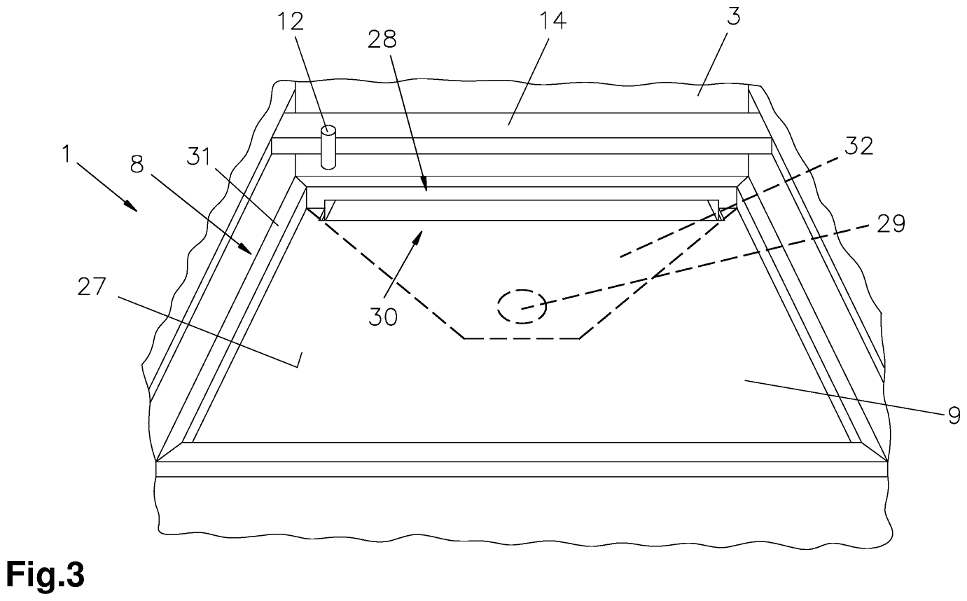

FIG. 3—another schematic illustration of the processing chamber of the laser plotter with the support surface present; simplified, for illustrative purposes only;

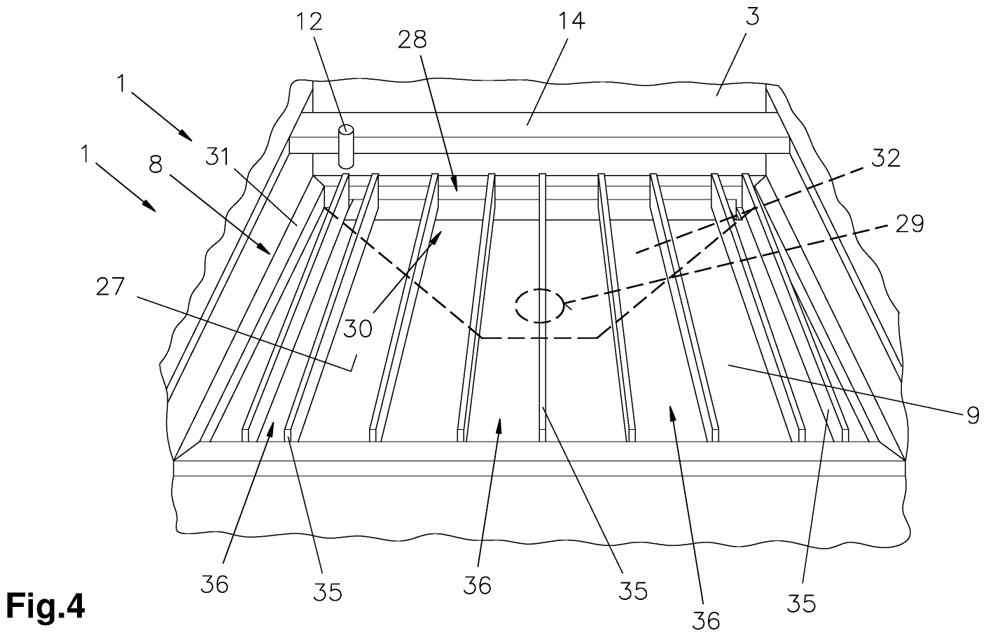

FIG. 4—another schematic illustration of the processing chamber of the laser plotter with slats inserted; simplified, for illustrative purposes only;

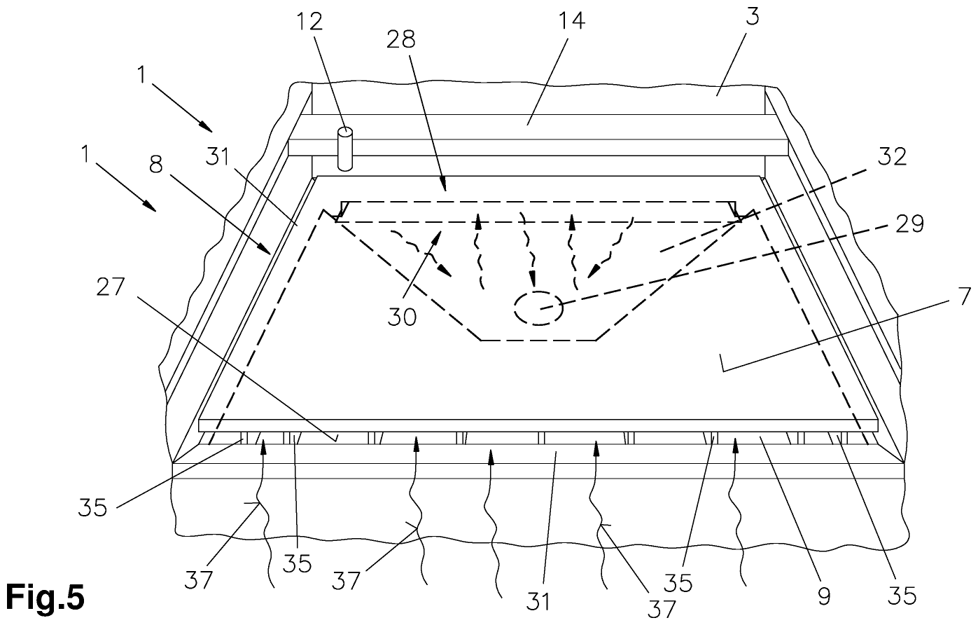

FIG. 5—another schematic illustration of the processing chamber of the laser plotter with a large-area workpiece inserted; simplified, for illustrative purposes only.

It should be stated by way of introduction that, in the individual embodiments, the same parts are provided with the same reference numbers or same component designations, respectively, wherein the disclosures contained in the entire description can, by analogy, be transferred to identical parts with identical reference numbers or identical component designations, respectively. The position details selected in the description, such as, e.g., top, bottom, lateral, etc., likewise relate to the figure described, and in the event of a change of position, they are to be transferred to the new position by analogy.

FIGS. 1 to 5 show an arrangement of an extraction device 1 in a laser plotter 2.

According to FIG. 1, a laser plotter 2 known from the prior art is shown, in which at least one, in particular two, irradiation sources 4 in the form of lasers 5, 6 are arranged and operated in a housing 3. The lasers 5 and 6 preferably act in alternating fashion on the workpiece 7 to be processed, wherein the workpiece 7 is positioned in a processing chamber 8 of the laser plotter 2, in particular on a processing table 9, which preferably can be adjusted vertically. A laser beam 10 emitted by the irradiation source 4 is sent via deflecting elements 11 to at least one movable focusing unit 12, from which the laser beam 10 is deflected in the direction of the workpiece 7 and focused for processing. The control, in particular the position control of the laser beam 10 with respect to the workpiece 7, is carried out by software running in a control unit 13, wherein the workpiece 7 is preferably processed line by line by adjustment of a carriage 14, on which the focusing unit 12 is also movably arranged, by means of preferably a belt drive in the X-Y direction.

In this context, for example, a graphic 16 and/or a text 16 can be created on an external component 15, in particular a computer or a control unit, using a commercially available software 16a, such as CoreIDRAW, Paint, etc., which is exported or transferred, respectively, to the control unit 13 of the laser plotter 2 in the form of a job, which control unit performs a conversion of the transferred data, in particular the graphic 16 and/or the text 16, for controlling the individual elements of the laser plotter 2.

Preferably, however, a web-based operator software 17 is used for the creation of a job, wherein for this purpose the component 15 or alternatively also directly the laser plotter 2 establishes a connection with the internet 18 and preferably a cloud 19. Via a browser, the operator software 17 can then be invoked and the configuration carried out, so that the job is then created by the operator software 17. This can be stored in a job database 20 in the cloud 19 so that it can be invoked at any time from any location in the world. In this context, it is also possible that a job is downloaded directly from the job database 20 for processing with the laser plotter 2, wherein this is carried out via the external component 15 or directly by the laser plotter 2 via its control/display elements, in particular touch screen, for which purpose the laser plotter 2, as shown schematically, establishes a connection with the internet 18 and further with the cloud 19.

After the data, in particular the created job, have been transferred to or loaded on, respectively, the laser plotter 2, the laser plotter 2, in particular its controller 13, processes the job. It is also possible for several jobs to be stored in the laser plotter 2 at the same time and processed sequentially. In laser plotters 2 of this type, it was previously common for a lid 23, which is preferably formed at least partially transparent 23a, of the laser plotter 2 to have to be closed in order to start a job to be processed. Subsequently, the operator can manually or alternatively automatically position the laser spot or a laser pointer, respectively, which is preferably positioned at the focusing unit 12, to the inserted workpiece 7, whereupon the job for processing the workpiece 7 can be started. The operator can then observe the carriage 14 with the focusing unit 12 via the preferably transparent lid 17, as it is moved and processed by the control device 13 according to the stored job. In order to easily follow the progress of the laser process, it is possible for the laser plotter 2 to be equipped with a status bar 24, so that the operator no longer has to look through the transparent lid 17 into the processing chamber 8, but instead has the progress displayed via the status bar 24, for which purpose the status bar 24 has several segments and/or colors. At the end of the job, the carriage 14 is then moved to the home position and terminated.

Since the processing of the workpiece 7 with the laser beam 10 results in vaporization of material during both cutting and engraving, exhaust gases 25 or vapors 25, respectively, are thus generated during the laser process, as shown schematically with arrows. These exhaust gases 25 can be harmful to humans, so that it is necessary for laser plotters 2 to be equipped with an extraction device 1 that extracts the resulting exhaust gases or vapors, respectively 25, or even smoke 25 from the processing chamber 8 so that no unpleasant or dangerous odors can be inhaled by the operator.

According to the present invention, an exhaust device 1 is now provided in which the processing table 9 is designed in such a way that an air flow 26 is formed below a support surface 27 of the processing table 9 for the workpiece 7 parallel to the support surface 27, i.e., the exhaust gases 25 are drawn from the upper side of the processing table 9 via an extraction opening 28 below the processing table 9, where they are conveyed downward via an exhaust opening 29 and then out of the housing 3 to the outside via a channel. In this context, it is possible that a filter can be integrated into the channel for exhaust gas cleaning, which filters out the hazardous or harmful, respectively, exhaust gases 25.

An essential difference from the prior art, in which the support surface 27 is mostly formed by perforated plates or grids or webs, respectively, whereby the air can simply be sucked downwards from the processing chamber 9, is that now the support surface 27 of the processing table 27 is formed over the entire surface, wherein, however, in a certain area, in particular on the rear side of the processing chamber 8, the extraction opening 28 of the processing table 9 and/or an extraction opening 30 is formed on a frame or boundary, respectively 31, surrounding the processing table 9, which surrounds the airtight support surface 27 of the processing table. This exhaust opening 28,30 opens into an extraction channel 32 formed below the support surface 27, from which the exhaust gases 25 are conveyed to the outside via the exhaust opening 29 and pipes connected thereto via an exhaust pump, i.e., in that an end plate 33 is arranged below the processing table 9 for preventing the air flow 26 or the exhaust gases 25, respectively, from being sucked down into the housing 3 of the laser plotter 2, and in that the extraction channel 32 is formed between the end plate 33 and the processing table 9, in particular the support surface 27, below the support surface for the workpiece 7, which exhaust channel is connected to an extraction opening 29 for conveying away the exhaust gases 25.

In order for an extraction channel 32, in which the air flow 26 of the exhaust gases 25 is formed in the direction of the exhaust opening 29, to be formed below the processing table 9, the end plate 33 is formed accordingly. Preferably, the exhaust duct 32 is limited to only a partial area of the processing chamber 8, in particular of the processing table 9, wherein a partial area of the end plate is formed V-shaped for this purpose, and the further area being recessed by a height 34, so that a concentration of the air flow 26 of the exhaust gases 25 is formed in the direction of the exhaust opening 29 arranged in the center of the recessed area.

It is of course possible that instead of a V-shaped recessed area of the end plate 33, one or more channels extending to the exhaust opening may also be formed, wherein the channels communicate with the extraction openings 28,30 to convey the exhaust gases 25 over the support surface 27, the extraction openings 28,30 to the exhaust opening 29.

In order to achieve an even better extraction of the exhaust gases 25, in particular during the cutting of the workpiece 7, several slats 35, preferably running parallel, are arranged in the frame 31, so that an air duct 36 is formed between the slats 35, which guides the exhaust gases 25 in the direction of the extraction opening 28,30, as can be seen best in FIG. 4. In this case, the slats 35 are preferably formed of acrylic glass and extend from the support surface 27 beyond the frame 31, so that they preferably project 5 to 20 mm beyond the frame 31. The slats 35 can be inserted into the frame 31 as individual elements or alternatively as a complete assembly so that all slats 35 can be removed or positioned in one step. In this context, it is possible for differently designed assemblies to have slats 35 of differing heights and widths, as well as air ducts 36 of different widths, so that the most diverse assemblies can be adapted to the workpieces 7 to be processed. However, if single slats 35 are to be used, it is advantageous that corresponding indentations (not shown) are arranged in the frame 31 into which the slats 35 are inserted. These indentations can also serve for positioning the entire assembly.

By using the slats 35, it is now possible that very large workpieces 7 can be processed, utilizing the entire interior space, in particular the processing chamber 8, as shown in FIG. 5, since the air for the exhaust device 1 can be sucked in between the workpiece 7 and the frame 31, as, due to the slats 35, the workpiece 7 is positioned above the frame 31 on the slats 35, i.e. air 37, which mixes with the exhaust gases 25, is sucked in from the front, which are subsequently conveyed below the workpiece 7 in the direction of the extraction channels 28,30 on the opposite rear side, where they mix with the exhaust gases 26, whereupon via the extraction openings 28,30 the mixture flows into the extraction channel 32 below the support surface 27 of the processing table 9 and from there is aspirated via the exhaust opening 29 and transported into the open, as this is shown schematically with arrows in FIG. 5.

Such a laser plotter 1 can thus be used with or without slats 35, since the air 35 or exhaust gases 25, respectively, are always aspirated via the extraction opening 28 and/or 30, preferably on the rear side of the processing chamber 8. It is essential that, due to the airtight support surface 27 of the processing table, an air flow 26 is necessarily formed via the extraction openings 28,30 and the extraction channel 32 below the processing table 9 to the exhaust opening 29 to which an extraction system, in particular a pump, is connected, wherein this is also the case with very large workpieces 7 or components, respectively.

As a matter of form, it should finally be emphasized that, for the better understanding of the structure of the engraving workflow 1 and its components or constituent parts, respectively, the same have in part been represented not to scale and/or enlarged and/or reduced in size, and above all only schematically.

In addition, individual features or feature combinations from the various exemplary embodiments shown and described can inherently form independent inventive solutions or solutions according to the present invention.

1-15. (canceled)

16. A laser plotter for processing a laser job for cutting, engraving, marking, and/or lettering a workpiece, comprising:
at least one housing with a processing chamber for positioning a workpiece on a processing table;
at least one irradiation source in the form of a laser; and
a control unit for controlling a carriage with a focusing unit, which is arranged movably thereon and is designed for deflecting a laser beam in a direction of the workpiece;
wherein in the processing chamber below a support surface of the processing table, an extraction device is arranged for extracting the exhaust gases produced during the laser job by generating an air flow;
wherein the processing table is designed in such a way that the support surface of the processing table is designed to extend over the entire surface and is airtight, and in that, in order to form an air stream, an extraction channel is arranged below the support surface, said extraction channel ending in an extraction opening, wherein the extraction channel is connected via at least one extraction opening to the processing chamber for extracting the exhaust gases or vapors, respectively, produced during the laser job.

17. The laser plotter according to claim 16, wherein an end plate is arranged parallel to the support surface and forms the extraction channel by means of a corresponding design.

18. The laser plotter according to claim 17, wherein the exhaust opening is arranged in the end plate, and wherein the extraction channel is designed to taper towards the exhaust opening.

19. The laser plotter according to claim 17, wherein the end plate is arranged at a defined distance from the support surface.

20. The laser plotter according to claim 17, wherein the processing chamber is delimited by a frame, and in that the end plate is arranged below the frame and is fixed to the frame.

21. The laser plotter according to claim 20, wherein the extraction opening is integrated into the frame and/or into the support surface.

22. The laser plotter according to claim 17, wherein the extraction opening is connected to the extraction channel below the end plate, wherein the extraction channel is connected to the extraction device, the extraction device being an extraction fan for discharging the air flow with the exhaust gases from the laser job via the extraction opening.

23. The laser plotter according to claim 16, wherein the extraction channel is limited to a partial area of the processing chamber.

24. The laser plotter according to claim 16, wherein the extraction opening is positioned in a center below the processing table and a part of the processing area is separated via blocking elements.

25. The laser plotter according to claim 16, wherein the support surface of the processing table is arranged above the bounding frame.

26. The laser plotter according to claim 16, wherein the support surface of the processing table is formed by air ducts, the air ducts being slats oriented from the front to the rear.

27. The laser plotter according to claim 26, wherein the slats extend over an upper side of the frame at a height between 5 mm and 20 mm.

28. The laser plotter according to claim 26, wherein the slats are arranged in uniformly distribution over the processing width of the support surface.

29. The laser plotter according to claim 26, wherein the slats are formed of acrylic glass.

30. The laser plotter according to claim 26, wherein the slats have a thickness between 2 mm and 10 mm.

31. The laser plotter according to claim 16, wherein the carriage is driven by a belt drive.

32. The laser plotter according to claim 16, wherein the workpiece is a flat workpiece.

33. The laser plotter according to claim 16, wherein the processing chamber is a closable processing chamber.

34. The laser plotter according to claim 16, wherein the extraction channel is arranged below the support surface parallel to the support surface.
